(19) United States
(12) Patent Application Publication
(10) Pub. No.: US 2026/0141213 A1
(43) Pub. Date: May 21, 2026

(54) IDENTIFYING RELEVANT DATA USING HIERARCHICAL KNOWLEDGE GRAPHS

(71) Applicant: Adobe Inc., San Jose, CA (US)

(72) Inventors: Zhenyu YAN, Cupertino, CA (US); Viswanathan SWAMINATHAN, Saratoga, CA (US); Ritwik SINHA, Cupertino, CA (US); Deepak PAI, Sunnyvale, CA (US); Anil KAMATH, San Jose, CA (US)

(21) Appl. No.: 18/953,630

(22) Filed: Nov. 20, 2024

(51) Int. Cl. G06N 3/042; G06N 3/0475

(52) U.S. Cl. CPC G06N 3/042; G06N 3/0475

(57) ABSTRACT

Methods, computer systems, computer storage media, and graphical user interfaces are provided for facilitating identification of relevant data using a set of hierarchical knowledge graphs. In one implementation, a data source relevant to a query is identified using a root knowledge graph. Thereafter, a data knowledge graph associated with the data source identified as relevant to the query is identified from among a plurality of data knowledge graphs. Such a data knowledge graph is used to identify a set of data relevant to the query. In embodiments, content may be generated, via one or more generative artificial intelligence (AI) models, based on at least a portion of the query and at least a portion of the set of data identified as relevant to the query. Such content may be provided for display via a graphical user interface.

### BACKGROUND

Various types of data are generally collected and used in various ways (e.g., analyze data, create content, etc.). For example, structured data, unstructured data, customer data, product data, social media data, public domain data, business data, etc., may be collected and accessible to use in various manners. By way of example only, such data may be used to enhance a prompt for an Artificial Intelligence (AI) technology, such as a Large Language Model (LLM), in an effort to obtain desired information in response to the prompt. For instance, in the context of content generation in association with a campaign, relevant data may be desired to be identified and included in a prompt along with a user input to facilitate creation of effective content for the campaign (e.g., an on-brand, personalized, and/or performant content). Determining or selecting specific data, for example to add context to a prompt for content generation, however, is oftentimes difficult and tedious.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating identification of relevant data using a set of hierarchical knowledge graphs. In various embodiments described herein, the identification of relevant data, based on a set of hierarchical knowledge graphs, is used to generate content (e.g., associated with a campaign) via AI (e.g., generative AI), such as a large language model(s) (LLM), a large vision model(s) (LVM), and/or a multimodal large language model(s) (MLLM). Among other things, embodiments described herein effectively and efficiently identify relevant data in an automated manner using a set of hierarchical knowledge graphs. As such, a root knowledge graph may be used to identify one or more data sources relevant to a query. In accordance with identifying a data source(s) relevant to the query, a data knowledge graph(s) associated with the identified data source(s) is accessed and used to identify a set of data relevant to the query. Thereafter, the identified relevant data may be used to generate content. In particular, the identified relevant data, or an indication thereof, may be included in a prompt generated to provide as input into an AI model and obtain, in response, a generated content in association therewith. In this regard, content may be efficiently and effectively generated in association with a desired or target result (e.g., as indicated in a query). In particular, various data identified as relevant to a query (e.g., a goal of a campaign or content) may be used, via AI technology, to generate suitable content. The resulting content may be analyzed or used (e.g., in association with a campaign). As relevant data is identified effectively and efficiently and used in conjunction with AI technology, the generation of content is performed efficiently, thereby reducing the computing resource utilization that would otherwise be used to iteratively generate content to obtain a desired content and/or perform testing of various content over an extensive testing period.

### BRIEF DESCRIPTION OF THE DRAWINGS

The technology described herein is described in detail below with reference to the attached drawing figures, wherein:

FIG. 1 is a block diagram of an exemplary system for identifying relevant data using a set of hierarchical knowledge graphs, suitable for use in implementing aspects of the technology described herein;

FIG. 2 is an example implementation for facilitating identification of relevant data using a set of hierarchical knowledge graphs, in accordance with aspects of the technology described herein;

FIG. 3 provides an example root knowledge graph, in accordance with embodiments described herein;

FIG. 4 provides an example method for facilitating identification of relevant data using a set of hierarchical knowledge graphs, in accordance with embodiments described herein;

FIG. 5 provides another example method for facilitating identification of relevant data using a set of hierarchical knowledge graphs, in accordance with embodiments described herein;

FIG. 6 provides another example method for facilitating identification of relevant data using a set of hierarchical knowledge graphs, in accordance with embodiments described herein; and

FIG. 7 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Different types of data are generally collected and used for various purposes. For example, structured data, unstructured data, customer data, product data, social media data, public domain data, business data, customer data, etc., may be collected and/or accessible to use in various manners. By way of example only, such data may be used to enhance a prompt for an AI model, such as an LLM, in an effort to obtain desired information in response to the prompt (e.g., on-brand, personalized, and/or performance data). For instance, in the context of content generation in association with a campaign, data may be included in a prompt as contextual data to a user input to facilitate creation of effective content for the campaign. Determining or selecting specific data, for example to add context to a prompt for content generation, however, is oftentimes difficult and tedious.

In conventional implementations, to determine data to include in a prompt to facilitate content generation, such data is generally manually selected by a user providing input or a query for the prompt. For example, a user may attempt to identify and/or select data to include in a prompt based on data that might be personalized for a particular audience segment, performant in association with a goal, resonates with the particular audience segment, etc. As the amount of data to consider is extensive, selecting valuable data may be difficult. For example, multiple sources of data may be available, but a user may select a particular source that is less suited for generating an effective content. As another example, a user may select overlapping data from different data sources, resulting in redundancies and/or ambiguities among the data. As yet another example, a user may miss a particular data source or data set altogether such that data that may be valuable in generating content is not used to do so. Further, data that may be considered valuable to a user may not result in generation of valuable content, may be outdated, or may not be well-suited for a particular audience. In some conventional implementations, heuristics may be used for data selection. Utilizing heuristics, however, may result in bias, over-simplification, staleness, and ineffective adaptation, among other drawbacks.

Accordingly, manually selecting data and/or using heuristics to select data may result in less effective content generation. As such, unnecessary computing resources are utilized to generate undesired or underperforming content. For example, computing and network resources are unnecessarily consumed in an effort to facilitate content generation based on less effective data, such as data that does not result in content personalized for a particular audience segment, performant in association with a goal, and/or resonating with the particular audience segment. In particular, computing resources may be used to generate the content. The content may then be evaluated or analyzed for effectiveness. In some cases, such evaluation or analysis may require testing the content, which also consumes various computing resources. In cases in which the content is determined to be unsuitable, the process may be iterated on to generate new content. Any number of iterations of generating content may be performed, with each iteration utilizing computing resources. For instance, computer input/output operations are unnecessarily increased in order to initiate multiple variations of content and, further, to test or evaluate the content over an extended amount of time in order to evaluate success of the different content. Further, as content is communicated over a network for various testing implementations, initiating multiple content assessments over an extended period of time to obtain feedback on the corresponding content decreases the throughput for the network, increases the network latency, and increases packet generation costs. Additionally, analyzing the feedback in relation to the multiple content variations unnecessarily consumes computing resources. For example, the feedback results must be stored for the duration of the test period for many different campaign variations. As another example, the feedback results may be manually analyzed and/or analyzed throughout the duration of the test period, thereby unnecessarily consuming computing and network resources.

As such, embodiments described herein are directed to facilitating identification of relevant data using hierarchical knowledge graphs. In embodiments, the identification of relevant data, based on a set of hierarchical knowledge graphs, is used to generate content (e.g., associated with a campaign) via AI (e.g., generative AI), such as a large language model(s) (LLM), a large vision model(s) (LVM), and/or a multimodal large language model(s) (MLLM). Among other things, embodiments described herein effectively and efficiently identify relevant data in an automated manner using a set of hierarchical knowledge graphs. As such, a root knowledge graph may be used to identify one or more data sources relevant to a query. In accordance with identifying a data source(s) relevant to the query, a data knowledge graph(s) associated with the identified data source(s) is accessed and used to identify a set of data relevant to the query. Thereafter, the identified relevant data may be used to generate content. In particular, the identified relevant data, or an indication thereof, may be included in a prompt generated to provide as input into an AI model and obtain, in response, a generated content in association therewith. In this regard, content may be efficiently and effectively generated in association with a desired or target result (e.g., as indicated in a query). In particular, various data identified as relevant to a query (e.g., a goal of a campaign or content) may be used, via AI technology, to generate suitable content. The resulting content may be analyzed or used (e.g., in association with a campaign). As relevant data is identified effectively and efficiently and used in conjunction with AI technology, the generation of content is performed efficiently, thereby reducing the computing resource utilization that would otherwise be used to iteratively generate content to obtain a desired content and/or perform testing of various content over an extensive testing period.

At a high level, a query or query data is obtained. For example, a user may provide a query that is obtained at a content generation manager. Thereafter, a root knowledge graph is obtained or accessed. The root knowledge graph is generally configured or structured in a manner that enables identification of one or more data sources that are relevant to the query. For example, nodes of the root knowledge graph may correspond with various aspects of campaign data, such as goals, target audience attributes, product data, company identity, brand identity, data sources, etc. Such a root knowledge graph may be traversed in accordance with the query to identify any number of data sources that may contain data relevant to the query. In this way, traversal of the root knowledge graph may be used to identify data sources that may provide personalized and effective data for use in generating content. In accordance with identifying a set of data sources deemed relevant to a query, the query data may be used to traverse corresponding data knowledge graphs. Data knowledge graphs generally graph knowledge associated with a particular data source. As such, assume a particular data source is identified as relevant to a query. In such a case, a data knowledge graph mapping data associated with the particular data source can be traversed to identify particular data that is relevant to the query. In this way, traversal of the data knowledge graph(s) may be used to identify particular data of the identified data sources that may result in personalized and effective data for use in generating content. The identified data may be included, or referenced, in a prompt for use in generating content. For example, the identified data may be included in a prompt that is input to an AI model, such as an LLM, to generate content. As the prompt includes or references the identified data relevant to the query, the generated content is more suited or relevant to the input query.

Advantageously, relevant data may be identified in an efficient and effective manner, resulting in generation of a more appropriate or suitable content. For example, the generated content may align more closely with the intent or desires expressed in the input query. As such, a more accurate and timely approach can be used to generate content and, moreover, result in content that is more effective and valuable. In addition, embodiments described herein provide an enhanced and intuitive user experience. In particular, in accordance with providing a query, the user is presented with helpful and accurate content. In this way, suitable campaign content is generated in a timely manner and may be more efficiently implemented to achieve designated goals.

Advantageously, efficiencies of computing and network resources can be enhanced using implementations described herein. In particular, using a set of hierarchical knowledge graphs to identify relevant data for use in association with AI technology to generate content provides for a more efficient use of computing resources (e.g., less computationally expensive, less input/output operations, higher throughput and reduced latency for a network, less packet generation costs, etc.) than conventional methods that may result in an extensive duration for testing and/or a manual analysis of various generated content, which is exacerbated with the extensive amount of content that can be created using AI technology. As more effective content generation is performed, unnecessary computing resources used to initiate and analyze multiple content variations is reduced. Further, the technology described herein conserves network resources, as content need not be served to an extensive number of individuals over a lengthy duration of time to evaluate the content, which results in higher throughput, reduced latency, and less packet generation costs as fewer packets are sent over the network. Moreover, the technology described herein enables identification of relevant data using a set of hierarchical knowledge graphs in an efficient and effective manner, thereby resulting in more effective content generation via an AI model. As described, using a set of hierarchical knowledge graphs enables a more computing-resource-efficient implementation for identifying relevant data. For example, based on analysis of the root knowledge graph, only a portion of data knowledge graphs (e.g., corresponding with the data sources identified in the root knowledge graph) are analyzed for identifying relevant data. Such a process is more computationally efficient than analyzing knowledge graphs associated with all the candidate or potential data.

Various terms are used throughout the description of embodiments provided herein. A brief overview of such terms and phrases is provided here for ease of understanding, but more details of these terms and phrases are provided throughout.

A campaign generally refers to a plan or set of actions and messages designed to achieve a particular goal or objective. In embodiments, the goal may be related to a financial or marketing goal, such as raising awareness, promoting a product or service, increasing sales, encouraging a particular behavior or outcome, etc. Campaign data includes any data associated with a campaign. Such campaign data may be captured in a campaign brief that describes the campaign. Examples of campaign data include a goal(s), a target audience(s), a message(s), a channel(s), a tactic(s), a measurement(s), a campaign asset(s), etc. A goal generally refers to a main purpose or objective associated with the campaign. A target audience generally refers to a particular group or segment of individuals the campaign is intended to reach. A target audience may be defined by any attribute, such as demographics, interests, behaviors, needs, etc. A message may refer to an idea or value the campaign communicates to inspire or encourage action or interest by an audience member. A channel generally refers to a platform or medium used to deliver a campaign asset(s) (e.g., social media, email, television, print, etc.). A tactic may include specific actions or variations that make up a campaign. A measurement may include a metric or key performance indicator used to track the success of a campaign or campaign asset.

Content generally refers to any content that may be generated. Content may be in the form of text, images, video, audio, etc. For example, content may be in the form of articles, blog posts, books, social media updates, emails, images, infographics, videos, illustrations, podcasts, music, audiobooks, etc. In some cases, content is or includes campaign content, which may be any content or material related to a campaign. Generally, campaign content may include material or messaging provided to an audience or individuals to engage, persuade, and/or encourage an action. Examples of campaign content include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), videos, text, images, etc.

Query data generally refers to any data associated with a query. In this way, query data may include the text in a query, or metadata associated therewith. Query data may include, for example, a goal, a target audience segment or attributes, a company identity, a brand identity, a product identity, data associated therewith, and/or the like. In embodiments, query data may be in the form of campaign data, as described herein.

A root knowledge graph is used to identify one or more data sources that may include data relevant to the query. A root knowledge graph generally refers to a structure that organizes and connects various knowledge, enabling efficient query handling through a network of interconnected nodes and relationships. In particular, the root knowledge graph provides a central framework used to identify and direct queries to appropriate or suitable data knowledge graphs. In this regard, a root knowledge graph acts as a navigational tool to determine which data knowledge graph to access for information, such as data associated with a query.

A data knowledge graph is used to identify relevant data associated with the identified relevant data sources. A data knowledge graph generally refers to a knowledge graph that relates to a specialized data segment of overall data that focuses on specific areas or topics, containing detailed information and relationships relevant to those particular domains. In this way, a data knowledge graph serves as a repository of detailed knowledge within a specific domain, such as product data, customer data, social media data, etc. As such, in some embodiments, a data knowledge graph may represent data associated with a particular data source.

A set of hierarchical knowledge graphs generally refers to a root knowledge graph and corresponding data knowledge graphs. In this regard, the root knowledge graph is a top level of a set of hierarchical knowledge graphs. Upon traversing the root knowledge graphs, the appropriate data knowledge graphs may be traversed. For example, assume traversing the root knowledge graph results in identification of a first data source and a second data source being relevant to a query. As such, a data knowledge graph corresponding with the first data source and a data knowledge graph corresponding with the second data source are accessed and traversed to identify relevant data.

Customer data generally refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; and other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

### Overview of Exemplary Environments for Facilitating Identification of Relevant Data Using Hierarchical Knowledge Graphs

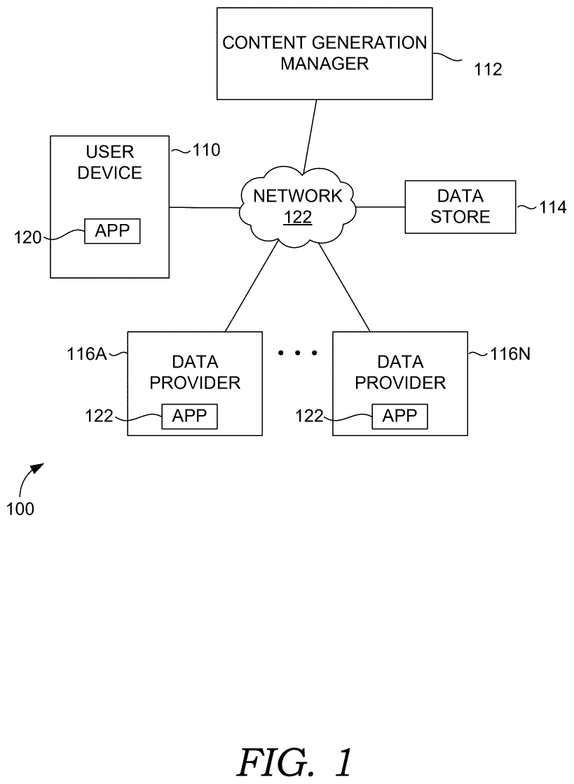

Referring initially to FIG. 1, a block diagram of an exemplary network environment 100 suitable for use in implementing embodiments described herein is shown. Generally, the system 100 illustrates an environment suitable for facilitating identification of relevant data using hierarchical knowledge graphs. In embodiments, the identification of relevant data, based on hierarchical knowledge graphs, is used to generate content (e.g., associated with a campaign) via AI (e.g., an LLM, LVM, and/or MLLM). Among other things, embodiments described herein effectively and efficiently identify relevant data using hierarchical knowledge graphs. Thereafter, the identified relevant data may be used to generate content. In particular, the identified relevant data, or an indication thereof, may be included in a prompt generated to provide as input into an AI model and obtain, in response, a generated content in association therewith. In this regard, content may be efficiently and effectively generated in association with a desired or target result (e.g., as indicated in a query). In particular, various data identified as relevant to a query (e.g., a goal of a campaign or content) may be used, via AI technology, to generate suitable content. The resulting content may be analyzed or used (e.g., in association with a campaign). As relevant data is identified effectively and efficiently and used in conjunction with AI technology, the generation of content is performed efficiently, thereby reducing the computing resource utilization that would otherwise be used to iteratively generate content to obtain a desired content and/or perform testing of various content over an extensive testing period.

In operation, a user, such as a marketer, can input or provide a query or query data and, based on the input, be automatically provided with one or more generated content items related to the query. In embodiments, query data may include a goal, a target audience segment or attributes, a company identity, a brand identity, a product identity, data associated therewith, and/or the like. The resulting generated content may be generated in a manner that is suitable to attain a desired performance or effectiveness of the content (e.g., in association with a campaign goal). As described herein, various data may be identified as relevant to a query and used to generate the content. In this regard, the AI technology can more effectively generate content using the supplemental data identified as relevant to the query.

The network environment 100 incorporates the identification of relevant data in an environment or system that generates content using AI technology. In FIG. 1, the network environment includes a user device 110, a content generation manager 112, a data store 114, and data providers 116a-116n (referred to generally as data source[s] 116). The user device 110, the content generation manager 112, the data store 114, and the data providers 116a-116n can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data providers 116a-116n may be in communication with the content generation manager 112 via a mobile network or the Internet, and the content generation manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another; for example, at least a portion of the content generation manager 112 and/or data store 114 may be integrated with the user device 110 and/or data providers 116. For instance, a portion of the content generation manager 112 may be integrated with a server in communication with a user device 110 and/or data providers 116, while another portion of the content generation manager 112 may be integrated with the user device 110 and/or data providers 116.

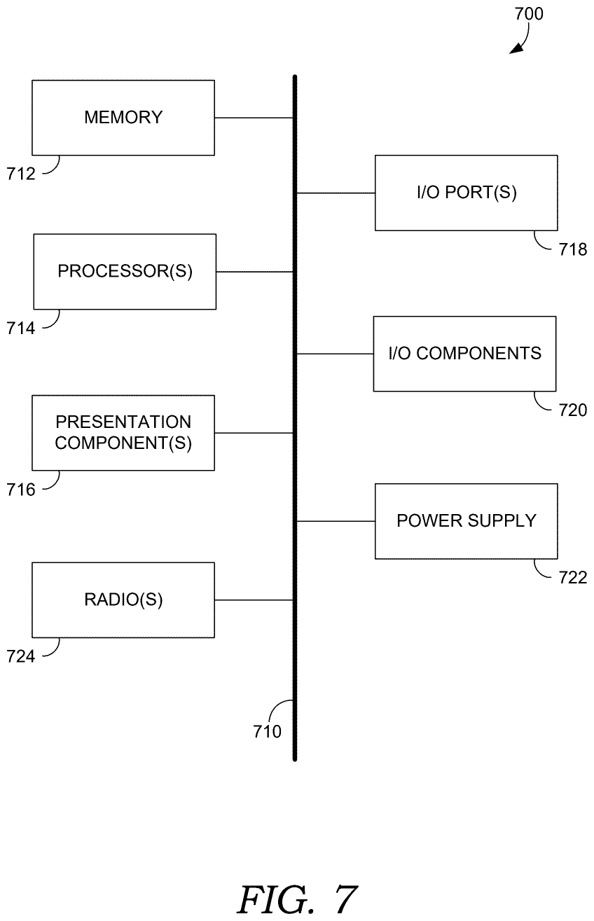

The user device 110 and the data providers 116 can be any kind of computing device capable of facilitating management of identifying relevant data using hierarchical knowledge graphs. For example, in an embodiment, the user device 110 and/or data providers 116 can be a computing device such as computing device 700, as described above with reference to FIG. 7. In embodiments, the user device 110 and/or data providers 116 can be a personal computer (PC), a laptop computer, a workstation, a mobile computing device, a personal digital assistant (PDA), a cell phone, or the like. Although illustrated separately, in some cases, the functionality described in association with the user device 110 and the data providers 116 may be performed via a single device (e.g., the user device also provides the query(s)).

The user device 110 and/or the data providers 116 can include one or more processors and one or more computer-readable media. The computer-readable media may include computer-readable instructions executable by the one or more processors. The instructions may be embodied by one or more applications, such as application 120 and/or application 122 shown in FIG. 1. The application(s) may generally be any application capable of facilitating identification of relevant data using hierarchical knowledge graphs. In some cases, the application(s), such as application 120, may facilitate providing query data, for example in association with a campaign. In some cases, the query data may be provided in the form of a query. In some implementations, the application(s) comprises a web application, which can run in a web browser, and could be hosted at least partially server-side (e.g., via content generation manager 112). In addition, or instead, the application(s) can comprise a dedicated application. In some cases, the application is integrated into the operating system (e.g., as a service). As one specific example application, application 120 may be a content management tool and/or analytics tool (e.g., Adobe® Experience Manager or Adobe® Analytics), or a portion thereof, that enables creation, management, delivery and/or analysis of content and digital assets. In some cases, such digital experiences may be provided across various channels, such as websites, mobile apps, forms, electronic communications, etc. Application 120 and/or 122 may be accessed via a mobile application, a web application, or the like. Applications 120 and 122 may be the same application or different applications.

User device 110 and/or data provider 116 can be a client device on a client-side of operating environment 100, while content generation manager 112 can be on a server-side of operating environment 100. Content generation manager 112 may comprise server-side software designed to work in conjunction with client-side software on user device 110 and/or data provider 116 so as to implement any combination of the features and functionalities discussed in the present disclosure. An example of such client-side software is application 120 on user device 110. Alternatively, the user device 110 and/or the data provider 116 may include server-side software. For example, the data provider may be a third-party data provider that provides data via a server. As another example, the data provider may operate in coordination with the content generation manager on the service side to access or use various types of data (e.g., some data of which may be proprietary data and some data of which may be third-party data). This division of operating environment 100 is provided to illustrate one example of a suitable environment, and it is noted that there is no requirement for each implementation that any combination of user device 110, content generation manager 112, and/or data provider 116 to remain as separate entities.

In an embodiment, the user device 110 and/or data provider 116 is separate and distinct from the content generation manager 112 and the data store 114 illustrated in FIG. 1. In another embodiment, the user device 110 and/or data provider 116 is integrated with one or more illustrated components. For instance, the user device 110 and/or data provider 116 may incorporate functionality described in relation to the content generation manager 112. For clarity of explanation, embodiments are described herein in which the user device 110, the content generation manager 112, the data store 114, and the data providers 116 are separate, while understanding that this may not be the case in various configurations contemplated.

As described, a user device, such as user device 110, can facilitate providing a query or query data to content generation manager 112 and, in response, view content generated in association with the query. Advantageously, the content is generated using additional data identified as relevant to the query, such that the content is more aligned or suitable in relation to the query. A user device 110, as described herein, may be operated by an individual or set of individuals that desires to view content, for example, generated for a campaign. As one example, a user device may be operated by a campaign manager or marketing manager. Such an individual may be affiliated with or a representative of a company associated with the campaign.

In some cases, generation of content in association with a campaign(s) may be initiated at the user device 110. For example, a user, such as an administrator or campaign manager, may input, provide, or select a query or query data. For instance, a user may input or select, via a user interface, a query associated with a campaign. In some cases, a user may provide a goal, an objective, a target audience, a target channel, a content type, etc., and/or an indication thereof. Such data may be provided via a text input box. In other cases, such data may be provided as a campaign brief including various campaign data for a campaign. For example, a user may select to upload a campaign brief document. The query data may include any type of data associated with a desired content and/or campaign. Any number and combination of various query data may be included. For example, a first set of query data provided via user device 110 for a first campaign content may include a goal and a target audience, while a second query provided via user device 110 for a second campaign content may include a goal and a product description. As can be appreciated, in some cases, an administrator, programmer, manager, or other individual affiliated with the campaign may input or select a set of query data to use for generating content.

Although only a single user device 110 is illustrated in FIG. 1, any number of user devices may operate in this environment. For example, a first user device may provide a first query in association with a first campaign, while a second user device may provide a second query in association with a second campaign.

An input or selection of a query or query data can be provided via an application 120 operating on the user device 110. In this regard, the user device 110, via an application 120, might allow a user (e.g., an administrator) to input, select, or otherwise provide a set of query data. The application 120 may facilitate the inputting of query data in a verbal form, a textual input form, a document form, etc. Such query data may be input at the user device 110 in any manner. For instance, upon accessing a particular application (e.g., a content management application), a user may be presented with, or navigate to, an input tool to input a query (e.g., via text input). As another example, a user may navigate to and select a document that includes campaign data for a query.

The user device 110 can communicate with the content generation manager 112 to provide the query or query data and/or request generation of a content item(s). In embodiments, for example, a user may utilize the user device 110 to provide a query via the network 122. For instance, in some embodiments, the network 122 might be the Internet, and the user device 110 interacts with the content generation manager 112 to provide a query for use in generating content. In other embodiments, for example, the network 122 might be an enterprise network associated with an organization. It should be apparent to those having skill in the relevant arts that any number of other implementation scenarios may be possible as well.

The data providers 116 are generally configured to provide data for use by the content generation manager 112, for example, to generate content. As described, a data provider may provide any type of data. In some cases, a data provider may provide data from a particular data source. Such a data source may include proprietary data and/or third-party data. For example, product details may be proprietary data provided by data provider 116A, while data provider 116N may provide third-party social media data. Any number of data providers may operate in this environment. For example, a first data provider may provide a first set of data, while a second data provider may provide a second set of data. In embodiments, the data may be provided to the data store 114 such that the data store 114 collects the data for reference or use by the content generation manager 112.

The data providers 116 can communicate with the content generation manager 112, data store 114, or other component to provide data. In embodiments, for example, the network 122 might be the Internet, and the data provider 116 interacts with the content generation manager 112 and/or data store 114 to provide various types of data for use in, among other things, generating content. In other embodiments, for example, the network 122 might be an enterprise network associated with an organization. It should be apparent to those having skill in the relevant arts that any number of other implementation scenarios may be possible as well.

With continued reference to FIG. 1, the content generation manager 112 can be implemented as server systems, program modules, virtual machines, components of a server or servers, networks, and the like. At a high level, the content generation manager 112 manages generation of content in accordance with data identified as relevant to a query. In operation, and at a high level, the content generation manager 112 can obtain a query, for example, associated with a campaign from user device 110. Based on the query, relevant data is identified using a set of hierarchical knowledge graphs. In particular, a root knowledge graph is used to identify one or more data sources that may include data relevant to the query. Thereafter, one or more data knowledge graphs that represent the data sources may be used to identify relevant data associated with the corresponding data source. In accordance with identifying relevant data, the relevant data may be used, or referenced, in generating a prompt to initiate generation of content in association therewith. Using AI models, such as an LLM, LVM, and/or MLLM, content may be generated based on the data identified as relevant to the query. As such, the content is generated in a manner to provide an effective content in association with a campaign. In some cases, the content may then be presented and/or used to present results via a user interface, for example, of the user device 110. Such content can additionally or alternatively be transmitted to data store 114 for access by any component managing or executing a campaign. Advantageously, utilizing implementations described herein enables generation of content to be performed in an efficient and accurate manner in accordance with data efficiently identified as relevant to a query.

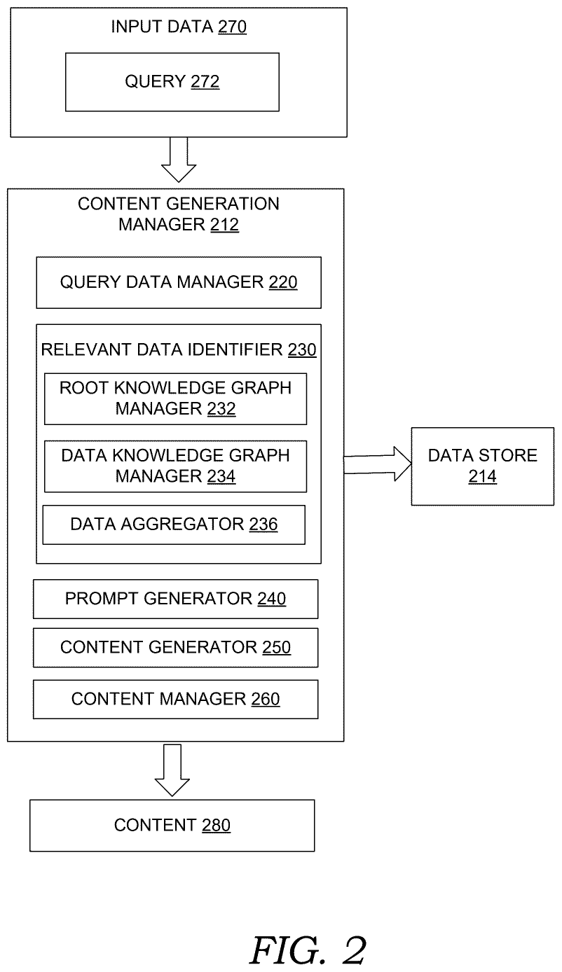

Turning now to FIG. 2, FIG. 2 illustrates an example implementation for facilitating content generation based on identifying relevant data using hierarchical knowledge graphs. The content generation manager 212 can communicate with the data store 214. The data store 214 is configured to store various types of information accessible by the content generation manager 212, or other server or component. In embodiments, user device (such as user device 110 of FIG. 1), data sources (such as data sources 116 of FIG. 1), and content generation manager 212 can provide data to the data store 214 for storage, which may be retrieved or referenced by any such component. As such, the data store 214 may store queries, root knowledge graphs, data knowledge graphs, data, and/or the like.

In operation, the content generation manager 212 is generally configured to facilitate or manage generation of content (e.g., in association with a campaign) using data identified as relevant based on hierarchical knowledge graphs. In particular, the content generation manager 212 manages generation of content using data identified as relevant to a query, wherein the relevant data is identified using a root knowledge graph to identify relevant data sources and one or more data knowledge graphs to identify relevant data associated with the identified relevant data sources. In this way, content may be generated in an efficient and effective manner. In embodiments, the content generation manager 212 includes a query data manager 220, a relevant data identifier 230, a prompt generator 240, a content generator 250, and a content manager 260. According to embodiments described herein, the content generation manager 212 can include any number of other components not illustrated. In some embodiments, one or more of the illustrated components 220, 230, 240, 250, and 260 can be integrated into a single component or can be divided into a number of different components. Components 220, 230, 240, 250, and 260 can be implemented on any number of machines and can be integrated, as desired, with any number of other functionalities or services.

The query data manager 220 is generally configured to manage query data that is used to search for data. Query data generally refers to any data associated with a query. In this way, query data may include the text in a query, or metadata or data associated therewith. A query generally refers to a request for information or data. In one embodiment, a query, or query data, is used to generate a prompt. In some cases, a query may be input by a user, for example, via a text input box. In this regard, the query manager 220 may obtain a query 272 as input data 270. As described, in some embodiments, a query may be obtained via a user, such as user device 110 of FIG. 1. In this regard, a user may provide a query via a user interface of the user device, which then provides the query to the content generation manager 212 (e.g., via a network). In some cases, a query may be input, uploaded, or selected via a user interface. Alternatively or additionally, a query may be computer-generated, for example, to perform data analysis or in response to performing data analysis. In this way, a computer may generate a query and provide the query to the content generation manager (e.g., via a network).

Initially, the query manager 220 obtains query data. Query data may be obtained in any number of ways. In some cases, as described, a query may be obtained by a user device, such as user device 110 of FIG. 1. In other cases, a query may be obtained from a data store, such as data store 214, or other computing device.

In some embodiments, query data may include data associated with a campaign or content to be generated. A campaign generally refers to a plan or set of actions and messages designed to achieve a particular goal or objective. Content generally refers to any content that may be generated. In some cases, content is or includes campaign content that may be any content or material related to a campaign. Generally, campaign content may include material or messaging provided to an audience or individuals to engage, persuade, and/or encourage an action. Content, such as campaign content, may take on any of a number of forms. In embodiments, content is in the form of a content item, such as an image and/or text, that conveys or portrays a message, product, item, etc. Examples of content include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), videos, text, images, etc.

In cases in which query data reflects a campaign, or a portion thereof, query data may include any data that indicates a goal, a target audience, a message, a channel, a tactic, a measurement, a timing, a messaging tone, etc., associated with a campaign and/or campaign content. A goal may refer to any goal or objective associated with a campaign and/or a campaign content(s). Examples of goals may include increasing sales for particular product, retaining customers, encouraging product use to increase opportunities for renewing subscription, etc. A target audience generally refers to a particular group or segment of individuals the campaign is intended to reach. A target audience may be defined by any attribute, such as demographics, interests, behaviors, needs, etc. A message may refer to an idea or value the campaign communicates to inspire or encourage action or interest by an audience member. A channel generally refers to a platform or medium used to deliver a campaign asset(s) (e.g., social media, email, television, print, etc.). A tactic may include specific actions or variations that make up a campaign. A measurement may include a metric or key performance indicator used to track the success of a campaign or campaign asset. Timing may indicate when campaign assets are to be delivered to audience members. A messaging tone refers generally to the tone of the message or campaign content.

In embodiments, the query manager 220 processes the query data. In this regard, the query manager 220 may parse the query to break down the query to constituent parts to understand its structure and meaning. For example, parsing a query may enable identification of key elements such as the main subject, any specific details, and the type of information or response being requested. In association with parsing, key terms or elements may be identified or extracted. For instance, the subject, specific details, and/or desired format of response may be identified. The context of the query may also be considered. For example, implicit information based on previous interactions or general knowledge about a topic may be identified.

Upon parsing and identifying elements, the query or query data may be optimized in various manners. For example, redundancies may be identified and removed. As another example expressions may be simplified. In this way, more complex phrases may be reduced to simpler, more direct expressions. As another example, focus may be on key elements. As such, extraneous information that does not contribute to the core request may be removed. As yet another example, components of the query may be rephrased for clarity and/or ambiguities removed. The resulting query data may be used to perform or execute a request for information. For example, the query data may be used to facilitate generation of a prompt to input to an AI model, such as an LLM, for instance to generate content (e.g., in association with a campaign).

The relevant data identifier 230 is generally configured to identify relevant data. In particular, in embodiments, the relevant data identifier 230 may identify data relevant to the query data. Relevant data may be identified for any number of reasons. As one example, relevant data may be identified to use in a prompt input to an AI model, such as an LLM. For instance, relevant data may be identified to include in a prompt as context data for generating content (e.g., in association with a campaign) via AI technology or performing another task associated with AI technology. Although many examples provided herein include using data identified as relevant in association with a prompt to input to an AI model, relevant data may be identified for any number of use cases. For example, relevant data may be identified for training an AI model or for performing analysis of such data.

In embodiments, to identify relevant data, the relevant data identifier 230 may use a set of hierarchical knowledge graphs. In this regard, hierarchical knowledge graphs may be used to identify relevant data, for example, for use in generating a prompt to initiate content generation via AI. Hierarchical knowledge graphs include a root knowledge graph and data knowledge graphs. The root knowledge graph of a set of hierarchical knowledge graphs is generally used to navigate to appropriate or suitable data knowledge graphs to identify relevant data. The data knowledge graphs generally represent various types of data and may be structured in any number of manners. In some embodiments, each data knowledge graph corresponds with a data source.

To identify relevant data using a set of hierarchical knowledge graphs, the relevant data identifier 230 may include, in embodiments, a root knowledge graph manager 232, a data knowledge graph manager 234, and a data aggregator 236. According to embodiments described herein, the content generation manager 212 can include any number of other components not illustrated. In some embodiments, one or more of the illustrated components 232, 234, and 236 can be integrated into a single component or can be divided into a number of different components. Components 232, 234, and 236 can be implemented on any number of machines and can be integrated, as desired, with any number of other functionalities or services.

The root knowledge graph manager 232 is generally configured to manage utilization of the root knowledge graph in identifying relevant data. In this regard, the root knowledge graph manager 232 may obtain or access a root knowledge graph. As described herein, a root knowledge graph generally refers to a structure that organizes and connects various knowledge, enabling efficient query handling through a network of interconnected nodes and relationships. In particular, the root knowledge graph provides a central framework used to identify and direct queries to appropriate or suitable data knowledge graphs. In this regard, a root knowledge graph acts as a navigational tool to determine which data knowledge graph to access for information, such as data associated with a query.

In some cases, the root knowledge graph manager 232 may initially obtain or access a root knowledge graph. A root knowledge graph may be obtained or accessed in any number of ways. For example, a root knowledge graph may be directly accessed, via a data store (e.g., data store 214), to traverse data. In this way, graph traversal may be performed directly on the root knowledge graph stored in a data store, such as a graph database. As another example, a root knowledge graph may be obtained from a data store (e.g., data store 214). For example, a root knowledge graph or a relevant portion of a root knowledge graph may be loaded into memory before traversing.

In some cases, a single root knowledge graph may exist and, as such, the root knowledge graph may be obtained or accessed. In other cases, multiple root knowledge graphs may exist. In such a case, the root knowledge graph manager 232 may identify which root knowledge graph(s) to obtain or access. As one example, different root knowledge graphs may exist for different entities or domains of knowledge. In this way, a first root knowledge graph may exist in association with a first company, a second root knowledge graph may exist in association with a second company, and so on. As such, based on a particular query (e.g., associated with a first company), a particular root knowledge graph (e.g., associated with the first company) may be selected.

A root knowledge graph may be structured in any number of ways. At a high level, a root knowledge graph generally includes nodes and edges. Nodes in a knowledge graph may represent entities or concepts, or data associated therewith, that are relevant to the domain of knowledge being modeled. In this regard, nodes may represent any entity or concept, for example, related to a domain(s) associated with the root knowledge graph. A domain(s) for the root knowledge graph may be of any type or extent. As one example, a domain may be a broad area of knowledge relevant to the particular application. For example, a domain may relate to campaign content generation. Entities may refer to real-world objects or subjects, such as people, places, products, organizations, etc. Concepts may refer to abstract ideas or categories that facilitate organization and/or classification of information (e.g., marketing strategy, customer satisfaction, revenue growth, etc.).

By way of example only, assume the domain relates to campaign content generation. In such a case, the nodes may represent various contexts, such as goals or objectives, product data, engagement metrics, target audience attributes, organization data, brand data, events, data sources, data types, and/or the like. In embodiments, the contexts may represent any type of data associated with the domain. Generally, the contexts may match or be similar to various query data that may be provided or included in a data set. A goal may refer to an objective or target that guides the use of the knowledge graph. In embodiments, the goal may be a campaign goal, such as increase revenue, obtain more clicks, improve brand awareness, enhance customer engagement, etc. Product data may relate to any data in association with a product. For example, product data may include price, product type, product features, product benefits, product availability, etc. Engagement metrics generally refer to any metrics indicating engagement with a product or brand (e.g., clicks, user interactions, feedback, purchases, etc.). Target audience attributes generally refers to attributes associated with a target audience. Such target audience attributes may include demographics (e.g., age, gender, location, etc.), interests, preferences, behavioral (e.g., new customers, returning customers, etc.), and/or the like. Organization data generally refers to any data associated with an organization. In some cases, organization data may include an organization identifier identifying or indicating an organization. Brand data generally refers to any data associated with a brand, such as a brand identity, brand features, brand values, etc. Events generally refer to occurrences of actions that may involve entities and have significance in the domain. A data source generally refers to a type or identity of a data source. By way of example only, data sources may include product data, customer data, social media data, website analytics, email marketing data, sales data, brand data, etc. Data sources may be indicated using any level of granularity. As one example, a data source may be represented as social media data. As another example, a set of data sources may be represented as social media source 1, social media source 2, social media source 3, and so on, to represent the different social media sources. A data type may generally refer to a type of data, such as, for example, demographic data, behavioral data, sentiment data, engagement data, transactional data, etc.

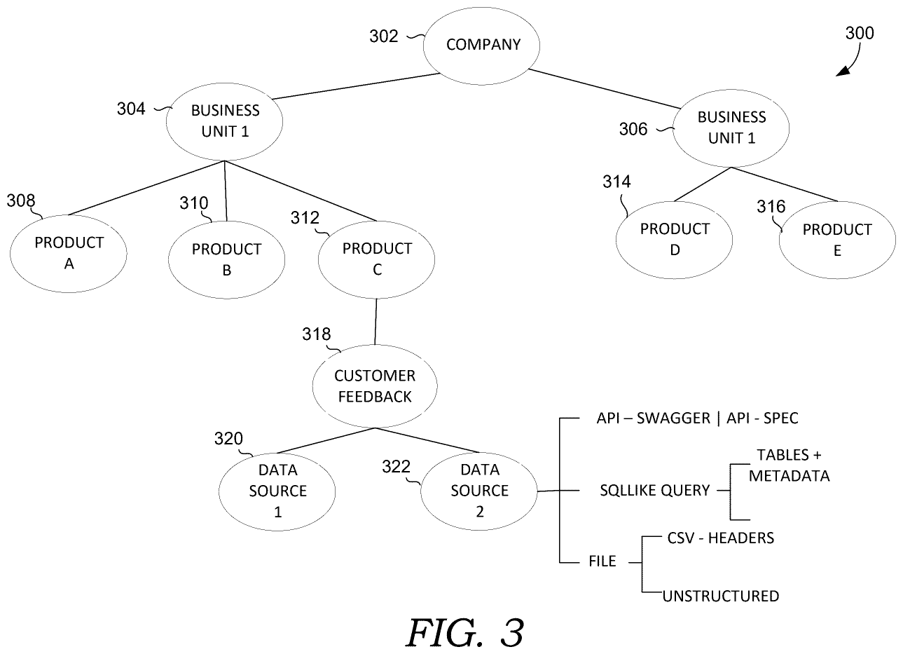

By way of another example, and with reference to FIG. 3, assume a root knowledge graph is in the form of a hierarchical knowledge graph 300 structured in accordance with an organization or business. Further assume various data sources may be accessible or used by the organization. For example, performance data (e.g., available in analytics tools), audience data (e.g., accessible in tools such as RTCDP and SFDC), campaign context (e.g., available in marketing tools), customer support information, (e.g., tickets available, for example, via ServiceNow), finance (e.g., available via a finance tool), public domain data (e.g., news articles), product usage (e.g., collected through product tools such as Amplitude), customer feedback (e.g., voice calls, reviews on Google/Yelp, forums, social media, net promoter score, etc.), and/or the like. A root knowledge graph may be structured with the company or organization as the root node 302. The child nodes 304 and 306 may represent different businesses units of the organization, such as node 304 representing business unit 1 and node 306 representing business unit 2. Each business units may correspond with various products. In this regard, node 304 representing business unit 1 may include products represented by nodes 308, 310, and 312, while node 306 representing business unit 1 may include products represented by nodes 314 and 316. Each node representing a product may correspond with various child nodes representing a type(s) of data associated therewith. For example, node 312 representing a product may have a child node 318 representing customer feedback. The nodes representing different types of data may further correspond with child nodes representing different data sources. For instance, node 318 representing customer feedback may relate to nodes 320 and 322 representing different data sources related to customer feedback. For example, nodes 320 and 322 may represent third-party reviews or user surveys, scores, etc. In some embodiments, the non-leaf nodes of the root knowledge graph may include pointers to child nodes, the number of which may depend on the organization structure and data sources. For instance, as one example, a level of the hierarchical structure may include teams. Depending on the team structure, the number of nodes may vary. For instance, a marketing team may be organized based on geographies and each geographical team may use different sets of tools. In some cases, such root knowledge graphs may be generated for each organization or enterprise, which may be custom created based on their business or operations.

In some cases, the leaf node may reference the data source or type of data source, and the corresponding data knowledge graph is accessed or traversed as described herein. Additionally or alternatively, a leaf node may include information about the data schema and a manner in which to retrieve it. For instance, with continued reference to FIG. 3, one example leaf node 322 may include data various data schemas and manners for retrieving data therefrom. In this regard, upon reaching the leaf node 322, the relevant data may be accessed or retrieved accordingly.

The edges of a root knowledge graph generally represent relationships between nodes. In some cases, the edges represent associative relationships. In this way, the edges or relationships between nodes represent associative links to capture non-hierarchical relationships, such as connections between different contexts and data sources. In other cases, the edges may represent hierarchical relationships. In this regard, the edges or relationships between nodes represent a parent-child relationship to show the hierarchy within a domain(s). Such a root knowledge graph may include broad categories at the top that branch out into more specific subcategories. In some embodiments, edges or relationships may be established between goal nodes and various context nodes to map out which contexts are relevant to which goals. Further, edges or relationships may link various context nodes to data source nodes indicating which sources are relevant for a given context. As such, data sources may be represented via data source nodes, which are used to identify data knowledge graphs to assess in association with query data. Representing data sources as nodes enables explicit relationships between different contexts (e.g., company, goals, target audience attributes, etc.) and different data sources, thereby facilitating traversal of the root knowledge graph. Further, data sources can be easily linked to multiple nodes, thereby allowing for complex interconnections and relationships. With such a root knowledge graph structure, adding new data sources as nodes can be manageable and scalable.

In some cases, the nodes and/or edges may be annotated with metadata to describe the content, relevance, and/or relationships. Such annotations may facilitate more efficient query processing. In embodiments, such metadata may be or include representations of data sources and/or data types. As such, node metadata may be used to assess data knowledge graphs in association with query data. Representing data sources via metadata can simplify structure of a root knowledge. In this way, metadata can be quickly accessed and processed, which can improve the performance of the root knowledge graph.

A root knowledge graph may be generated in any number of ways. In some cases, AI technology may be used to facilitate generation of a root knowledge graph. For example, AI technology may be used to merge duplicate entities and resolve ambiguities. As another example, AI technologies, such as machine learning models, may be used to identify and infer relationships between entities, predict missing links, classify entities or concepts, etc.

Generation of a root knowledge graph may occur at any time. As one example, a root knowledge graph may be initially generated for a domain (e.g., content creation) for use in identifying data sources and/or data. Such a root knowledge graph may be updated to refine the knowledge graph thereafter. For example, as new data or data sources become available, the root knowledge graph may be dynamically updated. In this way, new nodes and/or relationships may be added, deleted, and/or modified. In other cases, a root knowledge graph may be updated based on an occurrence of an event. For instance, a root knowledge graph may be refined on a periodic basis.

In embodiments, the root knowledge graph may be dynamically updated as new information or data is available or as the structure of knowledge evolves. Further, such a knowledge graph may be scalable such that new nodes and/or relationships may be added, deleted, or modified without significant restructuring.

In some cases, the root knowledge graph manager 232 may perform node and/or edge indexing. For example, indexes may be created for nodes and/or edges to enable quick lookups of nodes and/or relationships, thereby increasing efficiency of search operations. Metadata associated with nodes and/or edges may also be indexed to facilitate efficient filtering and retrieval.

In accordance with obtaining or accessing a root knowledge graph, the root knowledge graph manager 232 may traverse the root knowledge graph to identify one or more data sources, or data knowledge graphs associated therewith, to assess for data. In particular, query data may be used to traverse the root knowledge graph to identify one or more data sources relevant to the query data.

Root knowledge graph traversal may be implemented in any number of ways. In instances in which the root knowledge graph is structured in a hierarchical manner, the bottom nodes may represent various data sources such that data sources relevant to query data may be identified. In some cases, the bottom nodes may include metadata or tags indicating a data source. In this way, the bottom node in the hierarchical root knowledge graph may not directly represent a data source, but may provide such an indication via metadata or tags associated therewith.

Traversal of a hierarchical root graph may begin at any node. For example, a traversal may start at a root node of the root knowledge graph. As another example, traversal may begin at another level of the root knowledge graph, depending on the data provided in the query. A traversal direction may depend on the structure of the root knowledge graph (e.g., whether the data source nodes, or nodes indicating data source, are positioned as parent or child nodes) and/or the specific query data or analysis being performed. In downward traversal approach, the traversal moves from parent nodes to child nodes. In an upward approach, the traversal moves from the child nodes to the parent nodes. By way of example only, assume a top or high level of a root knowledge graph represents various goals associated with campaigns. Further assume various context nodes represent additional campaign data, such as a brand identity, an organization identity, target audience attributes, etc., and a bottom or low level of the root knowledge graph represents various data sources. In such a case, the root knowledge graph manager 232 may begin with a top-level node(s) that corresponds with a goal specified in an input query and may then traverse down the hierarchical structure in accordance with other input query data to arrive at one or more low-level nodes representing data sources.

Various methods may be used to traverse a hierarchical root knowledge graph. For example, depth-first search (DFS) may be used to explore as far down a branch as possible before backtracking. As another example, breadth-first search (BFS) may be used to explore all nodes at a present depth level before moving on to nodes at a next depth level. As yet another example, a hierarchical traversal may be used to perform traversal while respecting the parent-child relationships (e.g., traversing from a root node to leaf nodes in a tree-like structure). Alternatively or additionally, path queries may be used to navigate through specific paths and/or various graph algorithms (e.g., Dijkstra) may be used to perform traversal.

As described, a root knowledge graph may be structured as a networked knowledge graph. In this way, nodes are interconnected without being in a hierarchical structure, thereby allowing for multiple parent-child relationships and more complex interconnections. For traversal, a starting node may be selected in any number of ways. As one example, query data may be analyzed to select a key entity or concept. In some cases, an ordering or ranking of key entities and/or concepts may be generally predetermined. For example, assume a priority order is established as a goal, a company, a brand, a target audience attribute, and so on. Now assume a query is obtained that indicates a goal. In such a case, a starting node, or set of starting nodes, may be selected based on a similarity or match to the goal specified in the query. Now assume a query is obtained that does not indicate a goal but mentions a company name. In such a case, a node(s) corresponding with the company name may be selected for an initial node from which to traverse. Alternatively or additionally, a top entity or concept may be identified in association with query data based on an identified intent or priority indicated in the query. In this way, for a query that focuses or emphasizes a goal, a node(s) representing the goal, or similar goal, may be selected as a starting node(s). In this way, a root knowledge graph may be traversed by dynamically routing query data based on a goal and various context data indicated in the query.

Various approaches may be used to traverse such a root knowledge graph, including BFS to find a shortest path or explore nodes on a level-by-level basis, DFS to explore all possible paths from a node before moving to another branch, random walk to sample the graph, path queries to query specific relationships or paths, and/or various graph algorithms (e.g., Dijkstra, A Algorithm*, etc.), and/or the like.

By way of example only, in processing a query (e.g., “Generate a retention email talking about product features”), various query data may be identified indicating a goal and other context information (e.g., target audience attributes, company identity, brand identity, etc.). Using the goal (e.g., retention email generation) indicated in the query data, a corresponding node that represents the goal in the root knowledge graph may be identified. Thereafter, various context nodes that match the contextual information (e.g., product features) provided in the query may be identified (e.g., via an index). Beginning with the goal node, the graph is traversed to the connected context nodes (e.g., using the BFS traversal algorithm). For example, the root knowledge graph may be traversed from the node representing “retention email generation” to context nodes of “product feature.” From the context node(s), the graph may be traversed to related nodes that represent data sources (e.g., social media data source, customer data source, product data source, etc.). Such relationships indicate which data sources are relevant for the given goal and additional context.

In some cases, each data source is identified via traversal of the root knowledge graph for referencing corresponding data knowledge graphs. In other cases, data sources may be analyzed or ranked to select corresponding data knowledge graphs. For example, metadata may be used to filter and/or prioritize data sources based on relevance to the query. As another example, heuristics may be applied to prioritize the most relevant paths.

A root knowledge graph including nodes that reflect different aspects or contexts can facilitate a more effective data source selection. By way of example, using a company identity as context may facilitate a more relevant data source identification. For instance, the context of a particular company may facilitate identification of data sources that are specific to or more relevant to the company, such as internal databases, customer relationship management (CRM) systems, social media accounts specific to the company, etc. As another example, using target audience attributes as context may facilitate data source identification more relevant to the targeted audience.

In some embodiments, the root knowledge graph may include representations of types of data. In such a case, the root knowledge graph may further be traversed to identify the types of data that correspond with a data source. In some cases, nodes may represent various types of data and, as such, traversal of the root knowledge graph may result in identification of data types. In other cases, metadata may represent various types of data. As such, in accordance with identifying a data source node based on traversal of the root knowledge graph, metadata may be accessed to identify a data type(s) associated therewith.

In some cases, data sources and/or data type identifications in association with a particular query may be stored, for example, via data store 214. In this way, for subsequent queries that are similar or the same, the data source identification and/or data type identifications may be looked up or referenced (e.g., via data store 214) such that traversal of the root knowledge graph is not redundantly performed.

Turning to the data knowledge graph manager 234, the data knowledge graph manager 234 is generally configured to manage utilization of one or more data knowledge graphs to identify relevant data. In this regard, the data knowledge graph manager 234 may obtain or access one or more data knowledge graphs corresponding with traversal of the root knowledge graph. As described herein, a data knowledge graph generally refers to a knowledge graph that relates to a specialized data segment of overall data that focuses on specific areas or topics, containing detailed information and relationships relevant to those particular domains. In this way, a data knowledge graph serves as a repository of detailed knowledge within a specific domain, such as product data, customer data, social media data, etc. As such, in some embodiments, a data knowledge graph may represent data associated with a particular data source.

In some cases, a data knowledge graph is a subgraph of a knowledge graph. For example, a knowledge graph may exist that maps all data, and a particular knowledge graph refers to a section, segment, or portion of the knowledge graph. In other cases, a data knowledge graph is an independent or standalone knowledge graph that functions separately from other data knowledge graphs.

As described herein, a data knowledge graph may correspond with any granularity of data. As one example, a data knowledge graph may contain social media data generally, which includes various social media platforms. In another example, a first data knowledge graph may exist for a first social media platform, a second data knowledge graph may exist for a second social media platform, and so on.

Examples of data sources in association with a data knowledge graph include product databases, internal documentation, marketing materials, customer relationship management (CRM) systems, surveys and feedback, behavioral data, and analytics platforms. Product features generally refer to information about product features, which is often stored in product databases or product information management (PIM) systems. Such databases may contain detailed descriptions, specifications, and updates about the products. Internal documents, such as product manuals, feature lists, and development notes, may provide comprehensive details about the features of each product. Marketing materials may include brochures, product pages on the company's website, and marketing campaigns that describe product features and benefits. CRM systems may store detailed information about customer preferences, purchase history, and interactions with the company. Customer surveys, feedback forms, and reviews provide direct insights into user preferences and satisfaction levels. Behavioral data may reflect data collected from user interactions with the company's website, mobile apps, and other digital platforms, which may reveal preferences based on browsing history, click patterns, and purchase behavior. Analytics platforms may track user engagement metrics such as page views, time spent on site, click-through rates, and conversion rates. Social media platforms provide engagement metrics such as likes, shares, comments, and follower growth. Email marketing tools may track metrics such as open rates, click rates, and unsubscribe rates, providing insights into how users engage with email content. Content data may reflect various contents (e.g., advertisements, text, websites, images, etc.).

Such data, among other types of data, may be integrated into a data knowledge graph through data ingestion processes (e.g., via APIs, data pipelines, batch processing, etc.). The ingested data is mapped to the relevant nodes and edges in the data knowledge graph. For example, product features data may be linked to the “Product Features” node(s), user preferences data may be linked to the “User Preferences” node(s), and engagement metrics may be linked to the “Engagement Metrics” node(s). The data may be annotated with metadata to describe its source, type, relevance, etc.

In some cases, the data knowledge graph manager 234 may access or obtain data knowledge graphs corresponding with each data source identified via the root knowledge graph manager 232. For example, assume traversal of a root knowledge graph from a goal to a set of contexts results in identification of a set of data sources associated with such contexts. In such a case, data knowledge graphs associated with each identified data source may be accessed or obtained (e.g., via a link or reference in the root knowledge graph). In other cases, the data knowledge graph manager 234 may select a particular data knowledge graph or set of knowledge graphs from the data sources identified via the root knowledge graph manager 232. For example, data sources may be analyzed or ranked to select corresponding data knowledge graphs. For example, heuristics may be applied to prioritize data knowledge graphs.

A data knowledge graph may be structured in any number of ways. At a high level, a data knowledge graph generally includes nodes and edges. Such nodes may represent various entities and/or concepts, or data associated therewith. For example, a data knowledge graph associated with a data source may include entity nodes that represent real-world objects (e.g., people, places, organizations, products, etc.), class nodes that represent categories or types of entities, literal nodes that contain data values or attributes (e.g., names, dates, numbers, descriptions), property nodes that define relationships or attributes of entities, concept nodes representing ideas or concepts, document nodes representing documents or portions of content (e.g., text, images, articles, reports, web pages, etc.), event nodes representing occurrences or happenings (e.g., conferences, workshops, etc.). As such, the nodes of the data knowledge graph may represent various types of context.

The edges of a data knowledge graph generally represent relationships between nodes. In some cases, the edges represent associative relationships and, in other cases, the edges may represent hierarchical relationships. The nodes and/or edges of a data knowledge graph may be annotated with metadata to describe content, relevance, and/or relationships. Such annotations may facilitate more efficient query processing. As with the root knowledge graph, a data knowledge graph may be structured in a hierarchical manner or a non-hierarchical manner, or distributed manner.

By way of example only, assume a data knowledge graph represents a social media platform. In such a case, nodes of a data knowledge graph may represent social media posts, users (e.g., accounts or profiles), comments, likes, shares, etc. Edges may represent various relationships, such as “created by” (e.g., connecting a post to a user who created it), commented on (connecting a comment to the post it responds to), “liked by” (connecting a like to the user who liked the post), “shared by” (connecting a share to the user who shared the post), and/or the like. As another example, a node may represent posts including photos, videos, or stories; tags used to categorize posts; comments; users; reactions; reshares; and likes, while edges represent various relationships including posted by; tagged with; commented on; liked by; etc.

A data knowledge graph may be generated in any number of ways. In some cases, AI technology may be used to facilitate generation of a data knowledge graph. For example, AI technology may be used to merge duplicate entities and resolve ambiguities. As another example, AI technologies, such as machine learning models, may be used to identify and infer relationships between entities, predict missing links, classify entities or concepts, etc.

Generation of a data knowledge graph may occur at any time. As one example, a data knowledge graph may be initially generated for a data source for use in identifying data. Such a data knowledge graph may be updated to refine the knowledge graph thereafter. For example, as new data becomes available, the data knowledge graph may be dynamically updated. In this way, new nodes and/or relationships may be added, deleted, and/or modified. In other cases, a data knowledge graph may be updated based on an occurrence of an event. For instance, a data knowledge graph may be refined on a periodic basis.

In some cases, the data knowledge graph manager 234 may perform node and/or edge indexing. For example, indexes may be created for nodes and/or edges to enable quick lookups of nodes and/or relationships, thereby increasing efficiency of search operations. Metadata associated with nodes and/or edges may also be indexed to facilitate efficient filtering and retrieval.

In accordance with obtaining or accessing a data knowledge graph, the data knowledge graph manager 234 may traverse the data knowledge graph to identify data. In particular, query data may be used to traverse the data knowledge graph to identify data relevant to the query.

Data knowledge graph traversal may be implemented in any number of ways. In instances in which the data knowledge graph is structured in a hierarchical manner, the bottom nodes may represent various data or references thereto, such that data relevant to query data may be identified. In some cases, the bottom nodes may include metadata or tags indicating a data set. In this way, the bottom node in the hierarchical root knowledge graph may not directly represent data, but may provide such an indication via metadata or tags associated therewith.

Traversal of a data root graph may begin at any node. For example, a traversal may start at a root node of the data knowledge graph. As another example, traversal may begin at another level of the data knowledge graph, depending on the data provided in the query. A traversal direction may depend on the structure of the data knowledge graph (e.g., whether the data nodes, or nodes indicating data, are positioned as parent or child nodes) and/or the specific query data or analysis being performed. By way of example only, assume a top or high level of a data knowledge graph represents a target audience attribute or a company identity. Further assume various context nodes represent additional campaign data, and a bottom or low level of the data knowledge graph represents various data. In such a case, the data knowledge graph manager 234 may begin with a top-level node(s) that corresponds with a company identity and/or target audience attribute in an input query and traverse down the hierarchical structure in accordance with other input query data to arrive at one or more low-level nodes representing data.

Various methods may be used to traverse a hierarchical data knowledge graph. For example, depth-first search (DFS) may be used to explore as far down a branch as possible before backtracking. As another example, breadth-first search (BFS) may be used to explore all nodes at a present depth level before moving on to nodes at a next depth level. As yet another example, a hierarchical traversal may be used to perform traversal respecting the parent-child relationships (e.g., traversing from a root node to leaf nodes in a tree-like structure). Alternatively or additionally, path queries may be used to navigate through specific paths and/or various graph algorithms (e.g., Dijkstra) may be used to perform traversal.

As described, a data knowledge graph may be structured as a networked knowledge graph. In this way, nodes are interconnected without being in a hierarchical structure, thereby allowing for multiple parent-child relationships and more complex interconnections. For traversal, a starting node may be selected in any number of ways. As one example, query data may be analyzed to select a key entity or concept. In some cases, an ordering or ranking of key entities and/or concepts may be generally predetermined. Alternatively or additionally, a top entity or concept may be identified in association with query data based on an identified intent or priority indicated in the query. In this way, for a query that focuses or emphasizes a target audience segment, a node(s) representing the target audience segment, or similar target audience segment, may be selected as a starting node(s). In this way, a data knowledge graph may be traversed by dynamically routing query data based on a target audience segment and various context data indicated in the query.

Various approaches may be used to traverse such a data knowledge graph, including BFS to find a shortest path or explore nodes on a level-by-level basis, DFS to explore all possible paths from a node before moving to another branch, random walk to sample the graph, path queries to query specific relationships or paths, and/or various graph algorithms (e.g., Dijkstra, A Algorithm*, etc.), and/or the like.

By way of example only, in processing a query, various query data may be identified indicating context information (e.g., target audience attributes, company identity, brand identity, etc.). Using the query data, a corresponding node that represents the context data in the data knowledge graph may be identified. Thereafter, other various context nodes that match the contextual information provided in the query may be identified (e.g., via an index). The graph may be traversed to the connected context nodes (e.g., using the BFS traversal algorithm). From the context nodes, the graph may be traversed to related nodes that represent data. Such relationships indicate which data is relevant for the given query data.

In some cases, each set of data identified via traversal of the data knowledge graph is designated for referencing corresponding data. In other cases, a portion of data identified via traversal of the data knowledge graph may be designated for referencing corresponding data. For example, the data may be evaluated or analyzed in association with the query data or other data or metric to select particular data.

In some cases, data set identifications in association with a particular query may be stored, for example, via data store 214. In this way, for subsequent queries that are similar or the same, the data sets may be looked up or referenced (e.g., via data store 214) such that traversal of the data knowledge graph is not redundantly performed.

The data aggregator 236 is generally configured to aggregate data identified based on traversal of one or more data knowledge graphs. As can be appreciated, traversal of a single data knowledge graph may result in identification of any number of data or types of data. For instance, traversal of a data knowledge graph representing social media may result in identification of data associated with likes for a first social media platform and data associated with reactions for a second social media platform.

In some cases, the data aggregator 236 may aggregate references to or indications of the different data sets. In this way, the identified data may subsequently be accessed or obtained (e.g., via a prompt generator). Additionally or alternatively, the data aggregator 236 may access the data via various data sources and aggregate such data. For example, the data to be aggregated or compiled may exist in association with various data sources (e.g., hosted by one or more entities). The data aggregator 236 may retrieve the data (e.g., via requests, APIs, etc.) and aggregate the data into a set of data relevant to the query.

In some cases, the aggregated data, or indications or representations thereof, may be provided for display. For example, for a user that input a query, the data identified as relevant to the query, or a representation thereof, may be presented via a user interface of the user device. In some implementations, the user may be provided with an option to select all or a portion of the data for utilization, for example, to generate a prompt to create content.

As described, the data identified as relevant may be used in any number of ways. In one embodiment, the relevant data is used to generate content, such as content in association with a campaign. In this way, the relevant data may be used in association with a prompt for generating content. As such, the prompt generator 240 is generally configured to generate a prompt that may be used to initiate generation of content. A prompt generally refers to an input, such as an input text and/or graphic, that can be provided to a content generator 250, such as an LLM, LVM, and/or MLLM, to generate an output in the form of content. In embodiments, the prompt can include data, such as text and/or images, or an indication or reference thereto to influence an AI model (e.g., an LLM) to generate content having a desired content and/or structure. A prompt typically includes text given to an AI model to be completed. In this regard, a prompt generally includes instructions and, in some cases, identified relevant data to use in performing the analysis. Additionally or alternatively, the prompt may include images, or other non-text data, to influence an AI model, such as an LVM and/or MLLM, to generate an output having desired content and structure.

In accordance with embodiments described herein, a prompt may include or reference various data. By way of example only, a prompt may include an instruction or request, query data, and/or data relevant to the query, or references thereto, to be analyzed. An instruction generally refers to a request for generating content (e.g., text, images, and combinations thereof) for example, in accordance with query data. For instance, a prompt may include a request to generate content based on the query data and the corresponding relevant data (e.g., included in the prompt or referenced in the prompt). In some cases, an instruction may further indicate a type of content requested. For example, the prompt may request content in the form of an email, content in the form of an advertisement for social media, etc. In some cases, such a desired or target content may be input or specified by a user, such as a user of user device 110. In other cases, a content type may be a default setting. In yet other cases, a content type may be determined, for example, in association with a goal included in query data. In embodiments, a prompt may include or reference a content item(s) to modify or use as a basis for content creation.

As described, relevant data, or an indication or representation thereof, may be included in a prompt to use in creating content (e.g., in association with a campaign). Any number or type of data may be included in a prompt. In some embodiments, the prompt generator 240 may include the relevant data aggregated by the data aggregator 236, or a portion thereof, in the prompt to generate content. For example, various social media data, product data, and customer data may be included in the prompt. In other embodiments, the prompt generator 240 may include a representation or indication of the relevant data. In this way, the indications of the data may be included in the prompt and, as such, the content generator 250 may obtain the data, or search for the data, in accordance with the data indications provided in the prompt.

As can be appreciated, in some embodiments, the prompt may include additional or alternative data, such as output attributes or additional context. Output attributes generally indicate desired aspects associated with an output, such as generated content. For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a format for the response (e.g., image format). As another example, an output attribute may indicate a target language for generating the output. For example, the text data may be provided in one language, and an output attribute may indicate to generate the output in another language. Any other instructions indicating a desired output are contemplated within embodiments of the present technology.

Additional context may include any additional information that provides context to the request. Additional context may include a day/time, an indication of a brand, campaign data, a channel of communication of the campaign asset, etc. Any additional context may be provided to indicate or describe the desired content, campaign data, etc.

In some embodiments, the prompt generator 240 may be configured to select particular data, such as relevant data, to include in the prompt. As one example, relevant data may be selected to be under a maximum number of tokens required by a content generator, such as an LLM. For example, assume an LLM includes a 3,000-token limit. In such a case, text data totaling less than the 3,000-token limit may be selected. In this regard, prompts may have a size limit, thereby limiting the number of relevant data included in the prompt. As such, in some cases, using all identified relevant data may not be possible to be used as a prompt to an LLM due to size limitations of an LLM. Hence, it is necessary to select an optimal set of relevant data for feeding to the LLM for obtaining audience insights. Although generally described as using tokens (e.g., pieces of words, individual sets of letters within words, spaces between words, and/or other natural language symbols or characters), for input size, as can be appreciated, other input sizes may be used and may not necessarily be based on token sequence length but other data size parameters, such as bytes, number of words, etc.

Accordingly, in embodiments, the prompt generator 240 may be configured to select data, such as data relevant to the query, to include in a prompt to generate content. To identify relevant data to include, any aspect or score may be used. For example, in some cases, a relevant data score may be generated and used to select relevant data. The score may represent an importance or value associated with the relevant data. Such a score may indicate an extent or measure of some aspect for assessing data to include in the prompt. For example, a score may indicate relevance to informativeness, diversity, and/or the like. In other cases, relevant data associated with a selected or particular data source may be selected. For instance, in cases in which a product is referenced in a query, a data source more factually representing the product may be identified and used to generate the prompt.

The prompt generator 240 may format the prompt in a particular form or data structure. One example of a data structure for a prompt is as follows:

```
{ Instruction to generate content
{ Query Data
{ Set of data relevant to the query to use for generating content
  { Data Source 1; Data Set A
    ...
  { Data Source N; Data Set M
```

Any number of prompts may be generated. As one example, different prompts may be generated for different content generation requests (e.g., a first prompt for a first content generation request and a second prompt for a second content generation request). As another example, different prompts may be generated for different types of data (e.g., a first prompt for a first set of relevant data and a second prompt for a second set of relevant data).

The content generator 250 is generally configured to generate content. In this regard, the content generator 250 analyzes data in the prompt and outputs a content. In this way, the content generator 250 may generate text, images, videos, combinations thereof, etc. In embodiments, the content generator 250 takes, as input, a prompt generated by the prompt generator 240. Based on the prompt, the content generator 250 can generate content, for example, associated with a campaign included or indicated in the prompt. For instance, assume a prompt includes a query associated with content generation for a campaign, or a portion thereof. In such a case, the content generator 250 identifies or generates content, such as text and/or images, based on the query data and the data identified as relevant to the query included or referenced in the prompt.

The content generator 250 may be or include any number of AI models or technologies (e.g., generative AI models or technologies). In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the content generator 250 may be in the form of a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the content generator 250 may be in the form of a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the content generator 250, in the form of an LLM, LVM, and/or MLLM, can obtain a prompt and, using such information in the prompt, generate content(s), for instance, for a campaign. In some embodiments, the content generator(s) takes on the form of an LLM, LVM, and/or MLLM, but various other AI models can additionally or alternatively be used.

Use of an LLM, LVM, and/or MLLM may depend on the format of the data to be analyzed and/or the content to be generated. As one example, prompts including only text may be processed via an LLM, and prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. In this way, an MLLM may process both the text-based data and the visual-based data. Accordingly, although the content generator 250 is illustrated as a single component, any number of components may be used to create content.

The content manager 260 is generally configured to manage the generated content. In this regard, content generated via the content generator 250 may be managed and/or transmitted by the content manager 260. In some cases, in accordance with the content generator 250 generating content, the content may be stored, for example, in data store 214, for use in implementing in a campaign, performing subsequent campaign evaluations, making decisions related to the content, etc. Additionally or alternatively, content 280 may be provided to a user device or user for viewing, such as via user device 110 of FIG. 1, or another component for viewing or performing further analysis.

Further, the content manager 260 may use the content produced or output by the content generator 250 to generate or derive additional content. For instance, in some cases, the content may be aggregated with other content. For example, in identifying text content in association with a query, the text content may be combined with an image content associated with a product. As another example, content may be generated for different portions or aspects of a campaign. In this regard, content may be aggregated or compiled to generate a final content.

As another example, the content manager 260 may compare different contents to one another and provide a suggestion or recommendation for a particular content to be delivered to customers. For instance, effectiveness (e.g., represented via a score or ranking) associated with multiple generated contents may be compared to one another or ranked, and the highest effective content may be recommended or suggested for use.

In some embodiments, the content manager 260 may analyze the content and initiate a new or different content generation. For instance, based on a response to a first prompt or user feedback associated with a created content, the content manager 260 may trigger the prompt generator to generate a new content with a different instruction or based on different relevant data. Determining a scope for a new or different content creation may be performed in any number of ways. In some cases, a pattern, template, or hierarchical structure may be employed to identify a subsequent set of data to use in generating content. In other cases, AI technology may be used to facilitate generation of a subsequent relevant data scope to pursue.

Content 280 may be presented, via a user interface, in any number of ways. As one example, content may be presented in association with a query, query data, a campaign identity, a target audience, a company identity, a brand identity, a score (e.g., effectiveness score), etc. In this way, a user may select to view content associated with a particular query(s). In response, the user interface may present content generated in association with a query.

As can be appreciated, any number or type of content may be generated, and embodiments described herein are not intended to limit the type of content that may be requested or produced via AI technology. Further, various implementations may be used to generate content(s) in accordance with identified relevant data. Any number of implementations may be employed in accordance with embodiments described herein.

Although the relevant data identifier 230 is generally described in relation to identifying relevant data to generate content, the relevant data identifier 230 may be used in any number of environments or systems to identify relevant data. As one example, the relevant data identifier may be implemented to identify relevant data for training AI technology, such as an LLM.

### Exemplary Implementations for Facilitating Identification of Relevant Data Using Hierarchical Knowledge Graphs

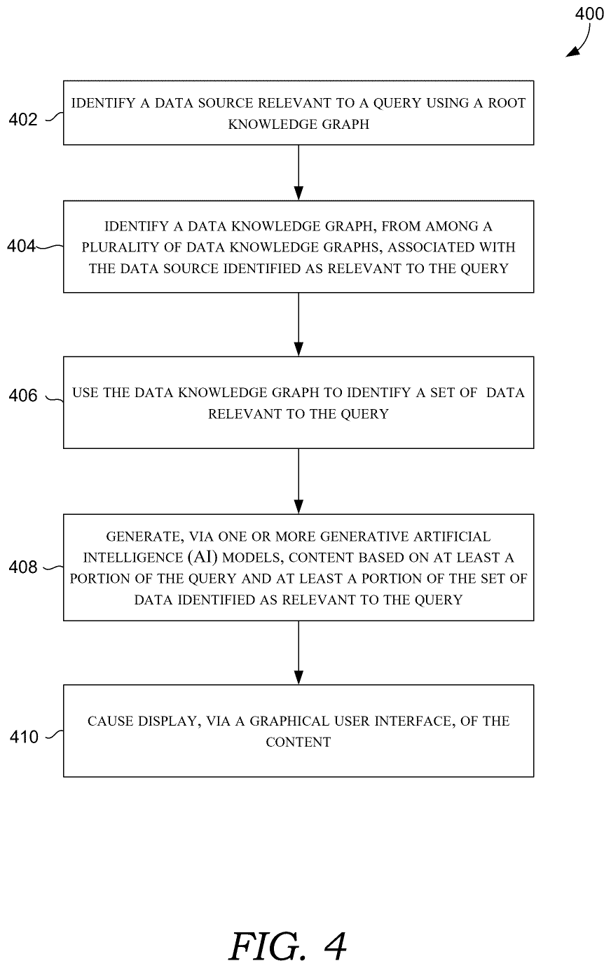

As described, various implementations can be used in accordance with embodiments described herein. FIGS. 4-6 provide methods of facilitating identification of relevant data using a set of hierarchical knowledge graphs, in accordance with embodiments described herein. The methods 400, 500, and 600 can be performed by a computer device, such as device 700 described below. The flow diagrams represented in FIGS. 4-6 are intended to be exemplary in nature and not limiting.

Turning initially to method 400 of FIG. 4, method 400 is directed to one implementation of facilitating identification of relevant data using a set of hierarchical knowledge graphs, in accordance with embodiments described herein. Initially, at block 402, a data source relevant to a query is identified using a root knowledge graph. In embodiments, a query is related to a campaign. In some cases, the query may include an indication of a goal and context data related to the goal, such as a target audience attribute, a product, a company, a brand, etc. The data source may be any type of data source, such as a product data source, a customer data source, a social media data source, etc. The root knowledge graph may include a set of nodes and edges. Such nodes may represent various types of data. For example, the root knowledge graph may include nodes associated with various goals, nodes associated with various context data related to the goal, and nodes associated with various data sources. To identify the data source(s), the root knowledge graph may be traversed from a node representing a goal to a node representing the data source. Any number of nodes representing various contexts may be traversed therebetween. Although this example starts traversal from a goal node, any node may be used as a starting point for traversal to or through a data source.

At block 404, a data knowledge graph associated with the data source identified as relevant to the query is identified from among a plurality of data knowledge graphs. In embodiments, each data knowledge graph corresponds with a different data source. For example, a first data knowledge graph includes or represents data associated with a first data source, and a second data knowledge graph includes or represents data associated with a second data source.

At block 406, the data knowledge graph is used to identify a set of data relevant to the query. In embodiments, the data knowledge graph is used to identify a set of data relevant to the query by traversing the data knowledge graph to or through nodes indicating subsets of data associated with the data source.

At block 408, content is generated, via an AI model, based on the query and the set of data identified as relevant to the query. In this regard, a prompt may be generated that includes the query and the set of data identified as relevant to the query. The AI model may then generate content in accordance with the prompt.

At block 410, the content is provided for display via a graphical user interface. For example, the content may be provided for display at a user device operated by a user that provides the query as input. Such content may be in any of a number of forms, including text, images, video, audio, mixed modal, etc.

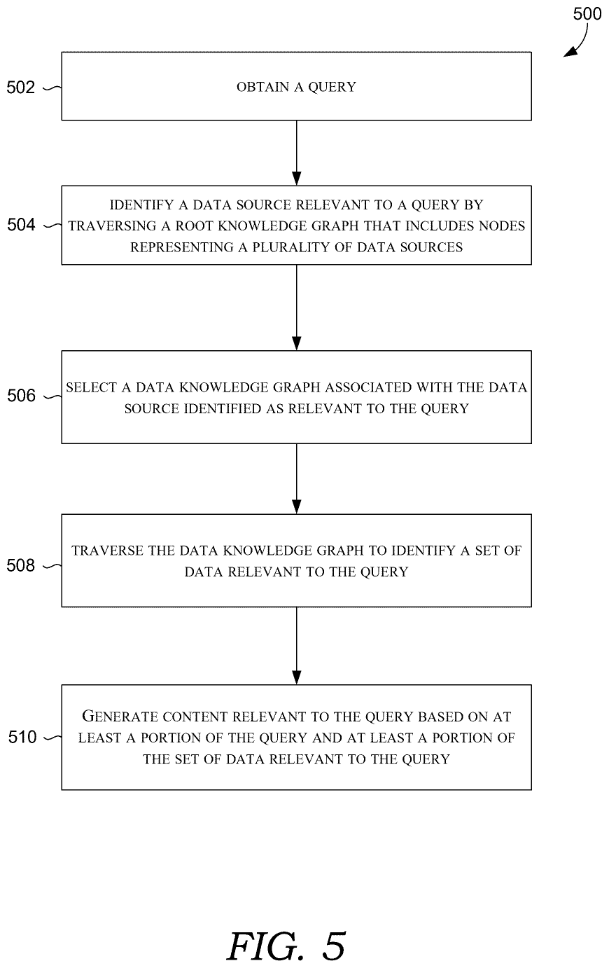

Turning to FIG. 5, method 500 of FIG. 5 is directed to another example implementation of facilitating identification of relevant data using a set of hierarchical knowledge graphs, in accordance with embodiments described herein. Initially, at block 502, a query is obtained. In embodiments, a query may be input by a user of a user device. In this regard, a user may input a query to initiate content generation in accordance with parameters or attributes indicated in the query.

At block 504, a data source relevant to a query is identified by traversing a root knowledge graph that includes nodes representing a plurality of data sources. In embodiments, traversing the root knowledge graph includes traversing from a node representing a goal that corresponds with the query to a node representing the data source.

At block 506, a data knowledge graph associated with the data source identified as relevant to the query is selected. Such a data knowledge graph may be selected from among a plurality of data knowledge graphs representing various different data sources.

At block 508, the data knowledge graph is traversed to identify a set of data relevant to the query. In this way, the data knowledge graph may be traversed from an initial node (e.g., associated with context provided in the query) to or through a node indicating or representing a subset of data of the data source.

At block 510, content relevant to the query is generated based on at least a portion of the query and at least a portion of the set of data relevant to the query. In embodiments, the content generation may be performed by generating a prompt that includes the query and the set of data relevant to the query, or portions thereof and, thereafter, obtaining as output content generated based on the prompt. In some cases, the prompt may further include other data identified as relevant to the query. Such other data may be identified by traversing another data knowledge graph associated with another data source.

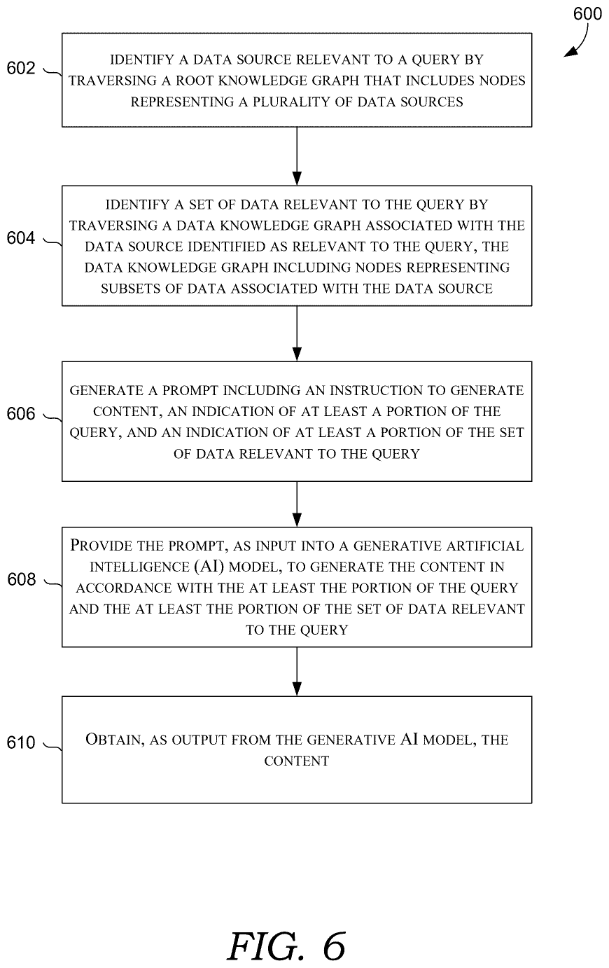

With reference now to FIG. 6, method 600 of FIG. 6 is directed to another example implementation of facilitating identification of relevant data using a set of hierarchical knowledge graphs, in accordance with embodiments described herein. At block 602, a data source relevant to a query is identified by traversing a root knowledge graph that includes nodes representing a plurality of data sources. In some embodiments, the query is related to a campaign and includes an indication of a goal associated with the campaign.

At block 604, a set of data relevant to the query is identified by traversing a data knowledge graph associated with the data source identified as relevant to the query. In embodiments, the data knowledge graph includes nodes representing subsets of data associated with the data source. Such a data knowledge graph may be identified or selected, from among a plurality of data knowledge graphs, based on the data knowledge graph being associated with the identified data source.

At block 606, a prompt is generated including an instruction to generate content, an indication of at least a portion of the query, and an indication of at least a portion of the set of data relevant to the query. In some embodiments, the set of data is aggregated with another set of data relevant to the query. Such data may be identified as relevant based on traversing another data knowledge graph associated with another data source identified as relevant to the query.

At block 608, the prompt is provided as input into a generative artificial intelligence (AI) model to generate the content in accordance with the at least the portion of the query and the at least the portion of the set of data relevant to the query. Thereafter, at block 610, the content output from the generative AI model is obtained. Such content may be provided for display via a user interface.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 7 in particular, an exemplary operating environment for implementing aspects of the technology described herein is shown and designated generally as computing device 700. Computing device 700 is just one example of a suitable computing environment and is not intended to suggest any limitation as to the scope of use or functionality of the technology described herein, and nor should the computing device 700 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, an illustrative power supply 722, and a radio(s) 724. Bus 710 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 7 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or non-volatile memory. The memory 712 may be removable, non-removable, or a combination thereof. Exemplary memory includes solid-state memory, hard drives, and optical-disc drives. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, and vibrating component. I/O port(s) 718 allow computing device 700 to be logically coupled to other devices including I/O components 720, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include radio(s) 724. The radio 724 transmits and receives radio communications. The computing device may be a wireless terminal adapted to receive communications and media over various wireless networks. Computing device 700 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. One or more computer storage media having computer-executable instructions embodied thereon that, when executed by one or more processors, cause the one or more processors to perform a method, the method comprising:
identifying a data source relevant to a query using a root knowledge graph;
identifying a data knowledge graph, from among a plurality of data knowledge graphs, associated with the data source identified as relevant to the query;
using the data knowledge graph to identify a set of data relevant to the query;
generating, via one or more generative artificial intelligence (AI) models, content based on at least a portion of the query and at least a portion of the set of data identified as relevant to the query; and
causing display, via a graphical user interface, of the content.

2. The media of claim 1, wherein the query is related to a campaign and includes a goal and one or more context data related to the goal.

3. The media of claim 1, wherein the root knowledge graph includes a set of nodes associated with a plurality of goals, a plurality of context data related to the goal, and a plurality of data sources.

4. The media of claim 1, wherein the data source is identified as relevant to the query based on traversal of the root knowledge graph from a node representing a goal to a node representing the data source.

5. The media of claim 4, wherein the traversal of the root knowledge graph from the node representing the goal to the node representing the data source includes traversing through one or more context nodes corresponding with query data associated with the query.

6. The media of claim 1, wherein each data knowledge graph of the plurality of data knowledge graphs corresponds with a different data source.

7. The media of claim 1, wherein the data knowledge graph maps data corresponding with the data source.

8. The media of claim 1, wherein the data source comprises a social media data source, a customer data source, or a product data source.

9. A computer-implemented method comprising:
obtaining, via a query data manager, a query;
identifying, via a root knowledge graph manager, a data source relevant to a query by traversing a root knowledge graph that includes nodes representing a plurality of data sources;
selecting, via a data knowledge graph manager, a data knowledge graph associated with the data source identified as relevant to the query;
traversing, via the data knowledge graph manager, the data knowledge graph to identify a set of data relevant to the query; and
generating, via a content generator, content relevant to the query based on at least a portion of the query and at least a portion of the set of data relevant to the query.

10. The method of claim 9 further comprising causing display, via a graphical user interface, of the content.

11. The method of claim 9, wherein generating the content relevant to the query comprises:
generating a prompt that includes the at least the portion of the query and the at least the portion of the set of data relevant to the query;
providing the prompt as input into an artificial intelligence (AI) model; and
obtaining, as output from the AI model, content generated based on the prompt.

12. The method of claim 9, wherein traversing the root knowledge graph comprises traversing from a node representing a goal that corresponds with the query to a node representing the data source.

13. The method of claim 9, wherein the data knowledge graph is selected from among a plurality of data knowledge graphs representing a plurality of data sources.

14. The method of claim 9, wherein generation of the content is further based on at least a second set of data identified as relevant to the query in accordance with traversing a second data knowledge graph.

15. A computing system comprising:
a processor; and
one or more computer storage media storing computer-useable instructions that, when used by the one or more processors, causes the one or more processors to perform operations comprising:
identifying a data source relevant to a query by traversing a root knowledge graph that includes nodes representing a plurality of data sources;
identifying a set of data relevant to the query by traversing a data knowledge graph associated with the data source identified as relevant to the query, the data knowledge graph including nodes representing subsets of data associated with the data source;
generating a prompt including an instruction to generate content, an indication of at least a portion of the query, and an indication of at least a portion of the set of data relevant to the query;
providing the prompt, as input into a generative artificial intelligence (AI) model, to generate the content in accordance with the at least the portion of the query and the at least the portion of the set of data relevant to the query; and
obtaining, as output from the generative AI model, the content.

16. The system of claim 15, wherein the operations further comprise providing, for display via a user interface, the content.

17. The system of claim 15 further comprising aggregating the set of data relevant to the query with another set of data identified as relevant to the query based on traversing another data knowledge graph associated with another data source identified as relevant to the query, wherein the prompt further includes the another set of data relevant to the query.

18. The system of claim 15, wherein the data source comprises a product data source, a customer data source, or a social media data source.

19. The system of claim 15, wherein the query is related to a campaign and includes an indication of a goal associated with the campaign.

20. The system of claim 15, wherein the data knowledge graph is selected from among a plurality of data knowledge graphs representing a plurality of data sources.
